(19) United States
(12) Patent Application Publication
(10) Pub. No.: US 2015/0031360 A1
(43) Pub. Date: Jan. 29, 2015

(54) METHOD AND DEVICE FOR LOAD BALANCING IN WIRELESS COMMUNICATION SYSTEM

(71) Applicant: Samsung Electronics Co., Ltd., Gyeonggi-do (KR)

(72) Inventors: Jung-Min Choi, Gyeonggi-do (KR); Dong-Wook Kim, Seoul (KR); Jeong-Jae Won, Gyeonggi-do (KR); Chung-Keun Lee, Seoul (KR); Hwa-Jin Cha, Gyeonggi-do (KR); Han-Seok Kim, Seoul (KR)

(21) Appl. No.: 14/341,690

(22) Filed: Jul. 25, 2014

(30) Foreign Application Priority Data
Jul. 26, 2013 (KR) 10-2013-0088798

(51) Int. Cl. H04W 36/22

(52) U.S. Cl. CPC H04W 36/22
USPC 455/436

(57) ABSTRACT

A method for a load balancing using statistical information in a base station of a wireless communication system is provided. The method includes measuring a load of at least one cell managed by the base station; exchanging load information of the measured cell with at least one neighboring base station; determining at least one Mobility Load Balancing (MLB) application candidate cell in which a Cell Individual Offset (CIO) change is necessary using the load information; determining at least one MLB application target cell in the at least one MLB application candidate cell; performing a CIO change procedure with the at least one MLB application target cell; selecting at least one User Equipment (UE) to notify a CIO change; and notifying the selected at least one UE of the CIO change.

### PRIORITY

The present application is related to and claims the benefit under 35 U.S.C. §119(a) of a Korean patent application filed in the Korean Intellectual Property Office on Jul. 26, 2013 and assigned Serial No. 10-2013-0088798, the entire disclosure of which is hereby incorporated by reference.

### TECHNICAL FIELD

The present disclosure relates to a method and device for load balancing in a wireless communication system, and more particularly, to a method and device for Mobility Load Balancing (MLB) in an Intra frequency environment.

### BACKGROUND

In general, load distribution or load balancing is technology for preventing an overload and enhancing availability of a computer resource and optimizing a response time to a request by uniformly dividing a load in which a plurality of programs process. Such load balancing is used in various fields, and nowadays, a research on a method of balancing an intercell load for enhancing availability of a radio resource in a wireless communication system has been performed.

Further, nowadays, an interest on a Long Term Evolution (LTE) system that supports a multi-carrier so as to transmit a large amount of data in a high speed has rapidly increased. However, in an LTE system standard, for intercell load balancing, load information that exchanges a load of cells managed by a base station with a neighboring base station is clearly described, it is clearly described that a load is balanced by performing handover of a User Equipment (UE) to a base station having a few load, and a function of supporting such a load balancing procedure is referred to as Mobility Load Balancing (MLB). The MLB may guide handover of a UE by adjusting Cell Individual Offset (CIO) used when performing handover from a source cell to a neighboring cell.

However, when changing CIO of each neighboring cell of a source cell for MLB, there is a problem that a handover success rate may be deteriorated. Further, there is a problem that a method for coexistence with a Mobility Robustness Optimization (MRO) function (function of automatically adjusting CIO of each neighboring cell using HO related statistics so as to optimize an HO success rate) is not suggested.

Therefore, a method and device for coexistence with an MRO function without deteriorating a handover success rate are requested.

### SUMMARY

To address the above-discussed deficiencies, it is a primary object to provide a method and device for Mobility Load Balancing (MLB) in a wireless communication system.

Another aspect of the present disclosure is to provide an MLB method and device that do not deteriorate a handover success rate in a wireless communication system.

Another aspect of the present disclosure is to provide a method and device for determining a UE to perform handover for MLB in a wireless communication system.

Another aspect of the present disclosure is to provide a method and device in which each base station exchanges load information with a neighboring base station and performs MLB based on the exchanged load information in a wireless communication system.

Another aspect of the present disclosure is to provide a method and device for MLB for coexistence with an MRO function in a wireless communication system.

In accordance with an aspect of the present disclosure, a method for a load balancing using statistical information in a base station of a wireless communication system includes: measuring a load of at least one cell managed by the base station; exchanging load information of the measured cell with at least one neighboring base station; determining at least one MLB application candidate cell in which a CIO change is necessary or to be performed using the load information; determining at least one MLB application target cell in the at least one MLB application candidate cell; performing a CIO change procedure with the at least one MLB application target cell; selecting at least one UE to notify a CIO change; and notifying the selected at least one UE of the CIO change.

Preferably, the method further includes monitoring MRO related statistical information; selecting at least one neighboring cell in which CIO fall back is necessary or to be performed using the MRO related statistical information; performing CIO fall back of the selected at least one neighboring cell; and excluding the at least one neighboring cell, having performed CIO fall back from MLB candidate neighboring cells for a predetermined time.

In accordance with another aspect of the present disclosure, a device of a base station that performs load balancing using statistical information in a wireless communication system includes: a base station load monitoring unit that measures a load of at least one cell managed by the base station and that exchanges measured load information with at least one neighboring base station; an MLB management unit that determines at least one MLB application candidate neighboring cell in which a CIO change is necessary or to be performed using the measured load information and that determines at least one MLB application target cell in the at least one MLB application candidate neighboring cell and that performs a CIO change procedure with the at least one MLB application target cell and that selects at least one UE to notify the CIO change; and a transmitting and receiving unit that notifies the selected at least one UE of the CIO change.

Preferably, the transmitting and receiving unit further includes an MRO management unit that monitors MRO related statistical information and that selects at least one neighboring cell in which CIO fall back is necessary or to be performed using the MRO related statistical information and that performs CIO fall back of the selected at least one neighboring cell and that excludes at least one neighboring cell, having performed CIO fall back from MLB candidate neighboring cells for a predetermined time.

In accordance with another aspect of the present disclosure, a method for a load balancing in a wireless communication system includes: monitoring loads of a source cell and at least one neighboring cell; determining at least one candidate neighboring cell in which handover related parameter adaptation for load balancing is necessary or to be performed in consideration of at least one of an overload condition of the source cell, a load ratio condition of the source cell and the neighboring cell, and a load difference condition between the source cell and the neighboring cell; determining at least one target neighboring cell from the at least one candidate neighboring cell using a function of determining a priority of neighboring cells based on handover related statistics; and adapting a handover related parameter value for the load balancing with the at least one target neighboring cell.

In accordance with another aspect of the present disclosure, a load balancing device in a wireless communication system includes: a monitoring unit that monitors a load of a source cell and at least one neighboring cell; and a Mobility Load Balancing (MLB) management unit that determines at least one candidate neighboring cell in which handover related parameter adaptation for load balancing is necessary or to be performed in consideration of at least one of an overload condition of the source cell, a load ratio condition of the source cell and the neighboring cell, and a load difference condition between the source cell and the neighboring cell and that determines at least one target neighboring cell from the at least one candidate neighboring cell using a function of determining a priority of neighboring cells based on handover related statistics and that adapts a handover related parameter value for the load balancing with the at least one target neighboring cell.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a configuration of a wireless communication system according to an exemplary embodiment of the present disclosure;

FIG. 2 is a flowchart illustrating a process for MLB in a base station according to an exemplary embodiment of the present disclosure;

FIG. 3 is a flowchart illustrating a process of selecting an MLB candidate cell in which CIO(s,n) adaptation is necessary or to be performed in a base station according to an exemplary embodiment of the present disclosure;

FIG. 4 illustrates signal intensity of a source cell and a neighboring cell according to an exemplary embodiment of the present disclosure;

FIG. 5 is a flowchart illustrating a process of selecting a target cell for a CIO change in a base station according to an exemplary embodiment of the present disclosure;

FIG. 6 is a flowchart illustrating a mobility change request process with a CIO change target cell selected by a base station according to an exemplary embodiment of the present disclosure;

FIG. 7 is a flowchart illustrating a process of determining a UE to perform handover for MLB in a base station according to an exemplary embodiment of the present disclosure;

FIG. 8 is a flowchart illustrating a CIO fall back process according to MRO related statistics in a base station according to an exemplary embodiment of the present disclosure;

FIG. 9 is a flowchart illustrating a process of selecting a neighboring cell in which CIO(s,n) fall back is necessary or to be performed in a base station according to an exemplary embodiment of the present disclosure;

FIG. 10 is a flowchart illustrating a method of determining CIO_delta according to MRO related statistics in a base station according to an exemplary embodiment of the present disclosure; and

FIG. 11 is a block diagram illustrating a configuration of a base station in a wireless communication system according to an exemplary embodiment of the present disclosure.

### DETAILED DESCRIPTION

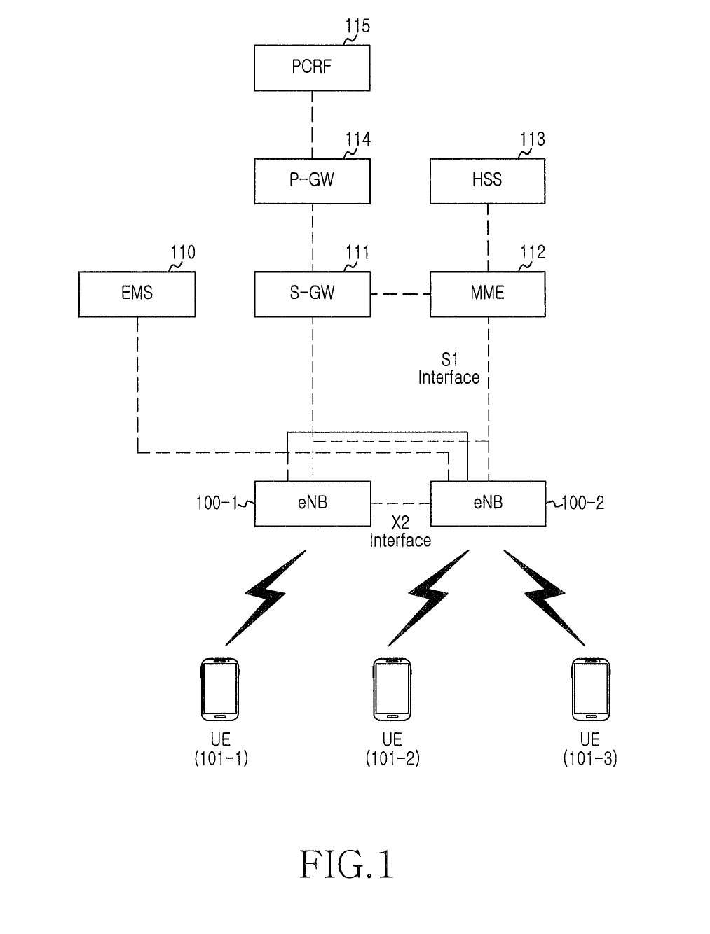

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Hereinafter, exemplary embodiments of the present disclosure will be described with reference to the accompanying drawings. Detailed descriptions of well-known functions and structures incorporated herein may be omitted to avoid obscuring the subject matter of the present disclosure. Further, the terms used herein are defined according to the functions of the present disclosure. Therefore, the terms may vary depending on a user's or an operator's intension and usage. That is, the terms used herein should be understood based on the descriptions made herein.

Hereinafter, in a wireless communication system according to an exemplary embodiment of the present disclosure, a method and device for performing MLB without lowering a handover success rate will be described. Hereinafter, in the present exemplary embodiment, for convenience of description, an LTE system is exemplified. However, the present disclosure may be applied with the same method in other wireless communication systems.

FIG. 1 illustrates a configuration of a wireless communication system according to an exemplary embodiment of the present disclosure.

Referring to FIG. 1, a wireless communication system according to an exemplary embodiment of the present disclosure may include a plurality of Evolved UTRAN Node-B (eNBs) (hereinafter, referred to as a ‘base station’) 100-1 and 100-2, an Element Management System (EMS) 110, a Serving Gateway (S-GW) 111, a Mobility Management Entity (MME) 112, a Home Subscriber Server (HSS) 113, a Packet Data Network (PDN) Gateway (P-GW) 114, and a Policy Charging & Rule Function (PCRF) 115.

The base stations 100-1 and 100-2 may be connected to at least one User Equipment (UE) 101-1 or 101-3 by wireless to process a packet call and perform a transmitting and receiving function of a wireless signal, and a radio resource control function and a modulation and demodulation function of packet traffic.

The base stations 100-1 and 100-2 according to the present exemplary embodiment may calculate a source base station load (its own load) and a load of a neighboring base station. Particularly, the base stations 100-1 and 100-2 may measure loads of the source base station and the neighboring base station using Equation 1. The base stations 100-1 and 100-2 may select an MLB candidate cell in which CIO(s,n) adaptation is necessary or to be performed based on the base station load. The base stations 100-1 and 100-2 may select a CIO change target base station among the selected MLB candidate base stations, perform a Mobility Change Request process with the selected target base station, select a target UE, and perform a Radio Resource Control (RRC) reconfiguration process with the selected UE, thereby performing an MLB process of the present exemplary embodiment.

The base stations 100-1 and 100-2 may collect statistics information of items represented in Table 3. The base stations 100-1 and 100-2 may select a neighboring base station in which CIO(s,n) fall back is necessary or to be performed based on statistical information, perform CIO(s,n) fall back of the selected neighboring base station, and exclude the selected neighboring base station from the MLB candidate base station.

The EMS 110 may provide an interface of an operator matching function such that an operator may perform operation and maintenance of the base station and provide software management, configuration management, performance management, and obstacle management functions.

The S-GW 111 may perform a user plane anchor function between a 2G/3G access system and an LTE system and manages and change a packet transmission layer of downlink and uplink data.

The MME 112 may process a control message using a Non-Access Stratum (NAS) signaling protocol with the base stations 100-1 and 100-2 and perform a function of mobility management, tacking area list management, and bearer and session management of a UE.

The HSS 113 may be a database management system that stores and manages parameter and location information of an entire mobile subscriber. The HSS 113 may manage important data such as an access ability, a basic service, and an additional service of a mobile subscriber and perform a routing function of an incoming subscriber.

The P-GW 114 may allocate an Internet Protocol (IP) address to a user UE, manage accounting and a transmission rate according to a service level, and perform an anchor function for mobility between an LTE system and a non-3GPP access system.

The PCRF 115 may generate a policy rule for dynamically applying a Quality of Service (QoS) and an accounting policy distinguished on service flow basis or may generate a policy that can commonly apply to a plurality of service flow.

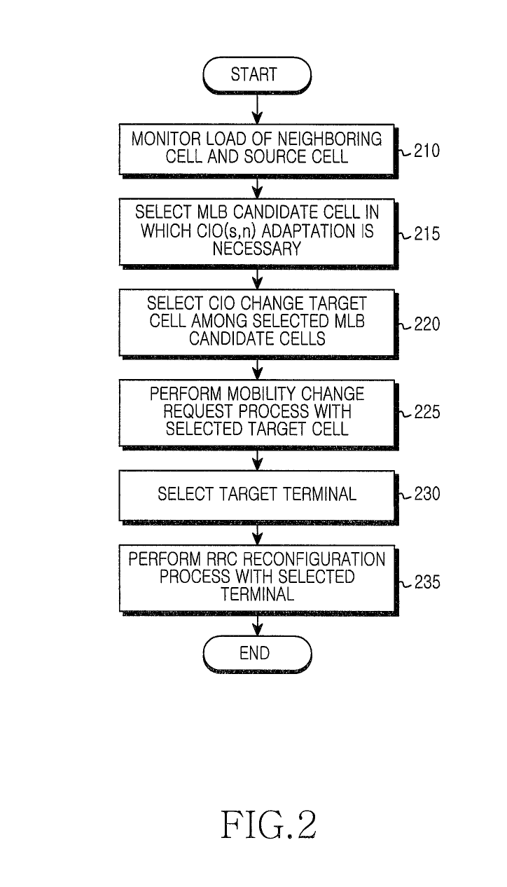

FIG. 2 is a flowchart illustrating a process for MLB in a base station according to an exemplary embodiment of the present disclosure. FIG. 2 illustrates a process of performing load balancing by changing CIO without deteriorating a handover performance in a base station.

Referring to FIG. 2, the base station monitors may loads of a neighboring cell and a source cell (210). Here, the source cell may be managed by the base station, and in this case, the base station may exchange cell load information with a neighboring cell managed by a neighboring base station using an X2 resource status update message.

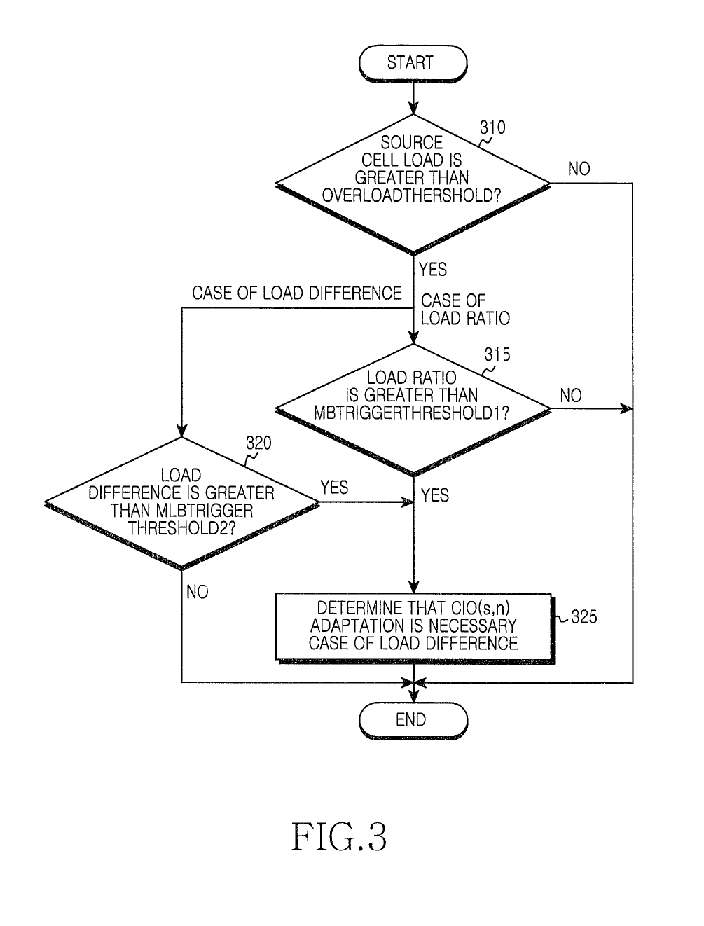

Thereafter, the base station may select an MLB candidate cell in which CIO(s,n) adaptation is necessary (215). Here, CIO(s,n) represents Cell Individual Offset (CIO), which is a parameter used when performing handover from a source cell (s) to a neighboring cell (n). By relaxing a handover condition through CIO(s,n) adaptation, the base station may induce handover from the source cell (s) to the neighboring cell (n). A process of selecting an MLB candidate cell will be described with reference to FIG. 3.

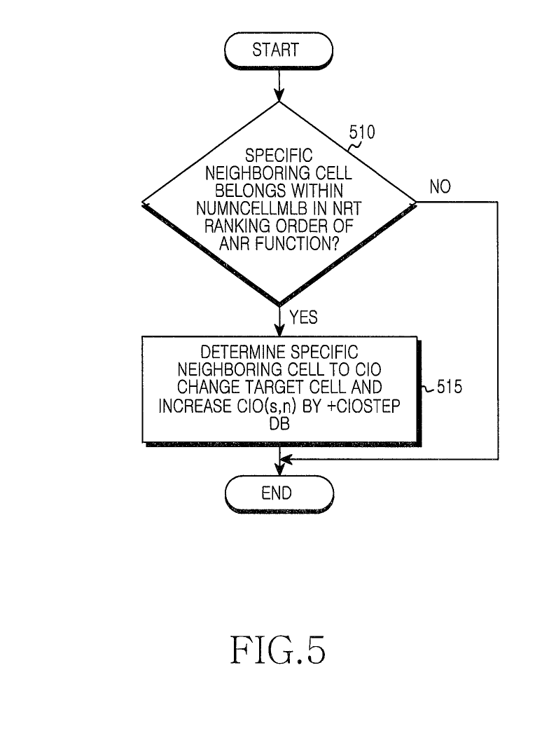

Thereafter, the base station may select a CIO change target cell among the selected MLB candidate cells (220). The process of selecting a CIO change target cell will be described with reference to FIG. 5.

Thereafter, the base station may perform a mobility change request process with the selected target cell (225). The base station may notify the target cell of CIO(n,$) to change through the process. Here, in order to reduce the handover UE number to the source cell by strengthening a handover condition from the target cell (n) to the source cell (s), CIO(n,$) of the target cell is changed.

Thereafter, the base station may select a target UE (230) and perform an RRC reconfiguration process with the selected UE (235). The base station may notify the selected UE of a CIO change through this process.

As shown in FIG. 2, a load in which the base station monitors and calculates will be described. The load is a base station load and is defined based on a radio resource, an Si Transport Network Layer (TNL) resource, an HW resource (CPU), and the RRC connection UE number. The base station may calculate a load through Equation 1 using a load calculation period periodLoad (system parameter and is set by an operator).

$${=}^{Load} \{ \begin{matrix}{Load}_{overflow} , if [ {Load}_{PRBfiltered} < {Load}_{overflow} ] \& & \{ \begin{matrix}{N}_{UE} > α \cdot {N}_{max} , or \\ {Load}_{CPU} > {Threshold}_{CPU} , or \\ max \{ {B}_{unused} , ( \begin{matrix}{B}_{unused} + \\ {B}_{NGBR}\end{matrix} ) / {N}_{UE} ) \} {Min}_{{BH}_{user}}\end{matrix} \\ {Load}_{PRBfiltered} , otherwise & \end{matrix} \qquad < Equation 1 >$$

where Load_{overflow} is a system parameter in which an operator sets, N_{Max} is the maximum RRC connection UE number that can receive per base station, N_{UE} is the present RRC connection UE number, α is a system parameter (set by an operator) representing a predetermined ratio, Load_{CPU} is a CPU load, Threshold_{CPU} is a critical value of a CPU load, B_{unused} is a non-using backhaul resource quantity, B_{NGBR} is a backhaul resource quantity using with Non Guaranteed Bit Rate (NGBR) use, Min_{BHuser} is a minimum backhaul resource quantity, Load_{PRBfiltered} is a load (is updated in every PRB load calculation period) of a radio resource (Physical Resource Block (PRB)), Load_{PRB}(t) is a PRB load for a control channel of a corresponding period in every PRB load calculation period, and t is a time index representing a present PRB load calculation period.

When Equation 1 satisfies a condition of Equation, the base station may determine a corresponding load value (e.g., Load_{overflow}=90%). In Equation 1, one of when N_{UE}>α·N_{Max}, i.e., when the present RRC connection UE number N_{UE} exceeds a predetermined ratio α (α is a system parameter and is set by an operator) of the maximum RRC connection UE number N_{Max} that can receive per base station or when Load_{CPU}>Threshold_{CPU}, i.e., when a CPU load Load_{CPU} exceeds Threshold_{CPU}, or when max{B_{unused},(B_{unused}+B_{nonGBR})/N_{UE}}<Min_{BHuser}, i.e., when a backhaul resource that can allocate to a new UE is less than a critical value Min_{BHuser} is satisfied and simultaneously, if Load_{PRBfiltered}<Load_{overflow}, a Load becomes Load_{overflow}.

If the foregoing condition is not satisfied, Load_{PRBfiltered} becomes a Load.

In Equation 1, Load_{PRBfiltered} is a load of an air resource PRB1 and is updated at every PRB load period, and a function of a time index t of Load_{PRBfiltered} is represented by Equation 2.

Load_{PBRfiltered}(t)=β·Load_{PRBfiltered}(t−1)+(1−β)·Load_{PRB}(t) <Equation 2>

Equation 2 represents an example that applies an Auto-regressive (AR) modelling method, and an Auto-regressive moving average (ARMA) modelling method may be applied to Equation 2. Here, B is fixedly set to a range of 0.0 to 1.0, t is a time index representing a present PRB load calculation period, and t−1 is a time index representing a previous PRB load calculation period.

Load_{PRB}(t) in Equation 2 is represented by Equation 3.

Load_{PRB}(t)=Load_{control}(t)+Load_{GBR}(t)+Load_{NGBR}(t) <Equation 3>

Load_{PRB}(t) is calculated with the sum of a PRB load Load_{control}(t) for a control channel of a corresponding period at every PRB load calculation period, a PRB load Load_{GBR}(t) for Guaranteed Bit Rate (GBR) traffic, and a PRB load Load_{NGBR}(t) for NGBR traffic. Load_{NGBR}(t) is represented by Equation 4.

Load_{NGBR}(t)=Σ_{q}Load_{NGBR}(q,t) <Equation 4>

where Load_{NGBR}(q,t) is a load of NGBR QoS Class Indicator (QCI)=q and is represented by Equation 5.

Load_{NGBR}(q,t)=min{CBR(q)×average PBR usage per bit×N(q),w(q)} <Equation 5>

where CBR(q) is a configured bit rate in which an operator sets for NGBR QCI=q, average PBR usage per bit is a PRB use rate necessary for 1 bit transmission for a calculation period of a present PRB load and is calculated in consideration of an average CQI of a corresponding cell, N(q) is the bearer number corresponding to QCI=q in which data to actually transmit has been for a present PRB load calculation period, and w(q) is a weight factor applied when calculating a load of QCI=q for actually used PRB_usage(q) for a present PRB load calculation period.

Load_{PRB}(t) in Equation 2 may be represented by Equation 6.

$${Load}_{PRB} ( t ) = 100 - max \{ {PRB}_{unused} , \frac{{PRB}_{unused} + {PRB}_{nonGBR}}{1 + {N}_{UE}} \} \qquad < Equation 6 >$$

where PRB_{unused} is non-used PRB usage for a present PRB load calculation period, and PRB usage is represented with 0.0-100.0%.

As shown in FIG. 2, cell load information in which the base station exchanges with a neighboring base station using an X2 resource status update message is as follows. The cell load information is a capacity value and may be calculated, as represented in Equation 7 or 8.

$$\begin{matrix}capacity value = 100 - γ \times ( load value ) & < Equation 7 > \\ capacity value = [ \frac{100}{1 + γ \times ( load value )} ] & < Equation 8 >\end{matrix}$$

A load value in Equations 7 and 8 represents a load in Equation 1. γ is a weight factor determined in consideration of a range of a load value, is a system parameter, is set by an operator, and a range thereof is 0.0-100.0.

[y] represents an integer most adjacent to y.

According to an LTE specification, because a capacity value within an X2 message exchanged between base stations may be represented with only an integer value of a range of 0-100%, when converting a range of a load value to a capacity value, a value γ appropriate to well express in a range of 0 to 100% may be obtained.

FIG. 3 is a flowchart illustrating a process of selecting an MLB candidate cell in which CIO(s,n) adaptation is necessary or to be performed in a base station according to an exemplary embodiment of the present disclosure. FIG. 3 illustrates a process of comparing a load of a source cell and a load of a neighboring cell and selecting an MLB candidate cell in which CIO(s,n) adaptation is necessary.

Referring to FIG. 3, the base station may determine whether a source cell load is greater than overloadThershold (system parameter and is set by an operator) (310), and if a source cell load is greater than overloadThershold (system parameter and is set by an operator), the base station may determine whether a load ratio is greater than mlbTriggerThreshold1 (system parameter and is set by an operator) (315), and if a load ratio is greater than mlbTriggerThreshold1 (system parameter and is set by an operator), the base station may determine that CIO(s,n) adaptation is necessary (325).

Here, the load ratio is defined as LoadRatio(s,n)=Load(s)/Load(n). Here, s represents a source cell, and n represents a neighboring cell.

Alternatively, in the following case, the base station may determine that CIO(s,n) adaptation is necessary.

If a source cell load is greater than overloadThershold (system parameter and is set by an operator) in operation 310, the base station may determine whether a load difference is greater than mlbTriggerThreshold2 (system parameter and is set by an operator) (320), and if a load difference is greater than mlbTriggerThreshold2 (system parameter and is set by an operator), the base station may determine that CIO(s,n) adaptation is necessary (325).

Here, the load difference is defined as LoadDifference(s,n)=Load(s)−Load(n).

A CIO(s,n) adaptation range that may adapt in the foregoing CIO(s,n) adaptation process is as follows. First, when performing handover, a ping pong phenomenon should be able to prevent. Intra-frequency handover is triggered by EventA3, and an entering condition to EventA3 defined to 3GPP TS 36.423 is represented by Equation 9.

Inequality A3-1(Entering condition)

Mn+Ofn+Ocn−Hys>Ms+Ofs+Ocs+Off <Equation 9>

where each parameter is defined as 3GPP TS36.331 in Table 1.

TABLE 1
Mn is the measurement result of the neighbouring cell, not taking into
account any offsets.
Ofn is the frequency specific offset of the frequency of the neighbour
cell (i.e. offsetFreq as defined within measObjectEUTRA corresponding
to the frequency of the neighbour cell).
Ocn is the cell specific offset of the neighbour cell (i.e.
cellIndividualOffset as defined within measObjectEUTRA corresponding
to the frequency of the neighbour cell), and set to zero if not
configured for the neighbour cell.
Ms is the measurement result of the serving cell, not taking into
account any offsets.
Ofs is the frequency specific offset of the serving frequency
(i.e. offsetFreq as defined within measObjectEUTRA corresponding to the
serving frequency).
Ocs is the cell specific offset of the serving cell (i.e.
cellIndividualOffset as defined within measObjectEUTRA corresponding
to the serving frequency), and is set to zero if not configured for
the serving cell.
Hys is the hysteresis parameter for this event (i.e. hysteresis as
defined within reportConfigEUTRA for this event).
Off is the offset parameter for this event (i.e. a3-Offset as defined
within reportConfigEUTRA for this event).
Mn, Ms are expressed in dBm in case of RSRP, or in
dB in case of RSRQ.
Ofn, Ocn, Ofs, Ocs, Hys, Offers expressed in dB.

A CIO change of the present exemplary embodiment is an Ocn change in Equation 9. In an Intra-Frequency, an entering condition of EventA3 is represented by Equation 10.

Mn>Ms+(Ocs−Ocn)+Off+Hys <Equation 10>

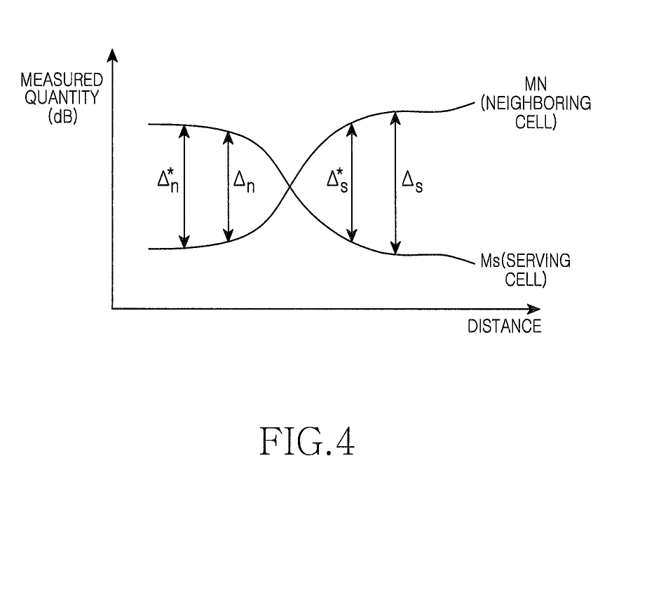

FIG. 4 illustrates signal intensity of a source cell and a neighboring cell according to an exemplary embodiment of the present disclosure.

Referring to FIG. 4, Δ=(Ocs−Ocn)+Off Hys and in FIG. 4, Δₛ, Δₙ represent a value Δ in a source cell (s->n) and a neighboring cell (n->s), respectively. Δ*ₛ, Δ*ₙ represent a change of a value Δ after a CIO change is performed by MLB due to an overload state of the source cell.

As shown in FIG. 4, as Δₛ decreases to Δ*ₛ, some UEs of the source cell quickly perform handover to a neighboring cell, and as Δₙ increases to Δ*ₙ, operation of reducing UEs that perform handover from a neighboring cell to a source base station is performed.

In order to prevent ping pong due to a CIO change, a value Δ*ₛ+Δ*ₙ should maintain a fixed value (pingpongControlThreshold is a system parameter and is set by an operator) or more.

A CIO(s,n) adaptation range that may adapt in the foregoing CIO(s,n) adaptation process is as follows.

A CIO change range may be set to a range between CIO_min and CIO_max. For this, a method in which the operator sets the CIO change range to a fixed value may be used, and a method in which the base station automatically sets a CIO change range may be considered.

In the method in which the base station automatically sets a CIO change range, +/−CIO_delta value based on CIO_mro defined in an MRO function may be set to a CIO range of a corresponding neighboring base station.

Here, CIO_delta may be set to automatically adapt in a range of 0 to cioDeltaMax (system parameter) based on MRO related statistics. That is, CIO_delta may be set to automatically adapt like CIO_min=CIO_mro−CIO_delta and CIO_max=CIO_mro+CIO_delta.

FIG. 5 is a flowchart illustrating a process of selecting a target cell for a CIO change in a base station according to an exemplary embodiment of the present disclosure.

Referring to FIG. 5, the base station may determine whether a specific neighboring cell of neighboring cells in which CIO(s,n) adaptation is necessary belongs within the superordinate numNcellMlb (system parameter and is determined by an operator) number in Non-Real Time (NRT) ranking order of an Automatic Neighbor Relation (ANR) function (510). In the present exemplary embodiment, the reason of selecting neighboring cells within the superordinate numNcellMlb number in NRT ranking order of an ANR function is to search for a CIO adaptation target cell of the numNcellMlb number. Accordingly, in order to search for the numNcellMlb number of CIO adaptation target cells, other algorithm of any form may be used. Here, a ranking of the ANR function is one of functions of calculating a priority of neighboring cells based on handover related statistics or MR statistics of a handover triggering event.

Thereafter, when the specific neighboring cell belongs within superordinate numNcellMlb, the base station may determine the specific neighboring cell to a CIO change target cell and increase CIO(s,n) by +CioStep dB (515). Here, a CIO(s,n) value to be changed should exist within a range of CIO_min and CIO_max.

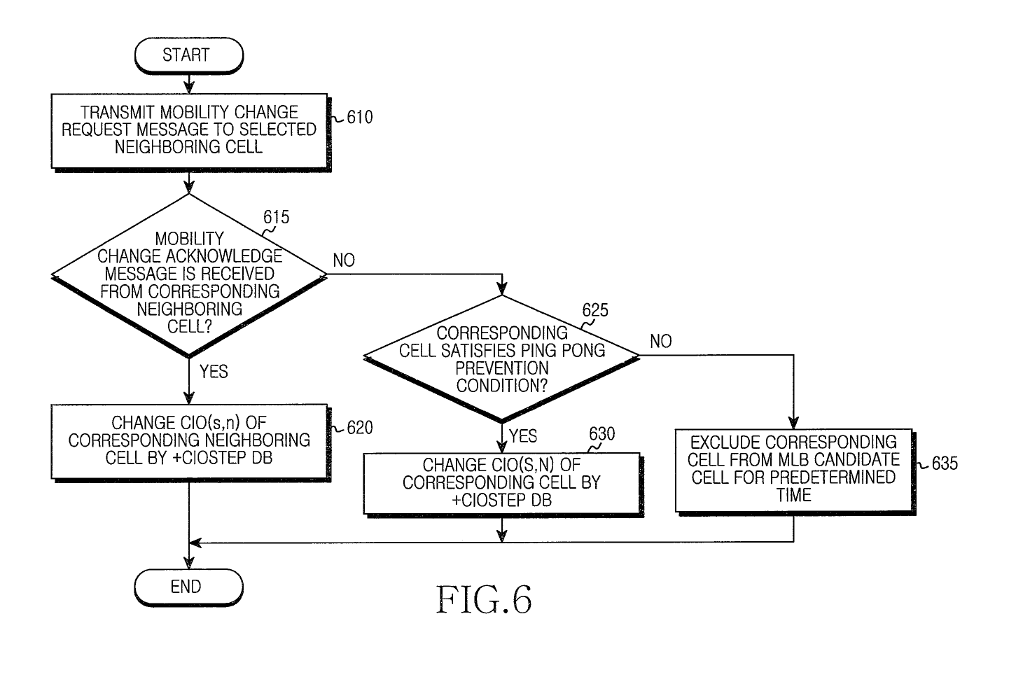

FIG. 6 is a flowchart illustrating a mobility change request process with a CIO change target cell selected by a base station according to an exemplary embodiment of the present disclosure.

Referring to FIG. 6, a source cell may transmit a mobility change request message to a selected neighboring cell and request to change CIO(s,n) by +CioStep dB (610).

The source cell may determine whether a mobility change acknowledge message is received from a corresponding neighboring cell (615), and if a mobility change acknowledge message is received from a corresponding neighboring cell, the source cell may change CIO(s,n) of the corresponding neighboring cell by +cioStep dB (620).

If a mobility change failure message (cause: “Valid out of allowed range”) is received from a corresponding neighboring cell, the source cell may determine whether the corresponding neighboring cell satisfies a ping pong prevention condition (625).

If the corresponding neighboring cell satisfies a ping pong prevention condition, the source cell may change CIO(s,n) of the corresponding neighboring cell by +cioStep dB (630).

If the corresponding neighboring does not satisfy a ping pong prevention condition, the source cell may exclude the corresponding neighboring cell from an MLB candidate cell for a predetermined time (waitTimer) (635).

The corresponding neighboring cell may be included again in the MLB candidate cell after the predetermined time. When a corresponding MLB candidate cell transmits “Valid out of allowed range”, it represents that Ocn (n->s) managed by the corresponding neighboring cell became CIO_min(n, s). When a target cell and a source cell are in the same base station, a corresponding message may be transmitted and received within the base station.

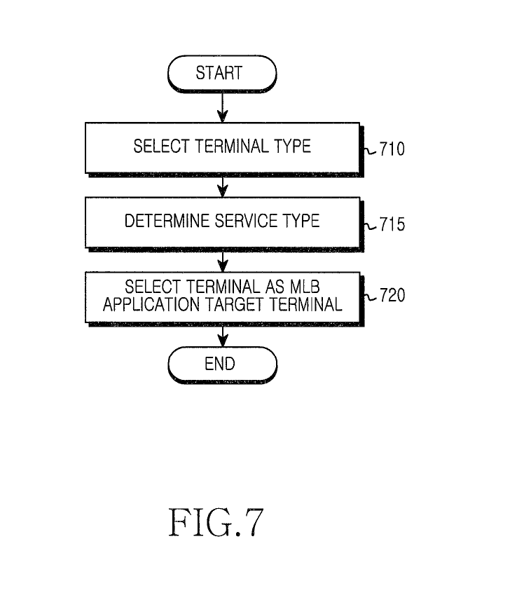

FIG. 7 is a flowchart illustrating a process of determining a UE to perform handover for MLB in a base station according to an exemplary embodiment of the present disclosure. In FIG. 7, the base station may transmit an RRC connection reconfiguration message to a selected UE.

Referring to FIG. 7, the base station may select a UE type (710). In this case, the base station may select a newly RRC connected UE or an UE to perform a CIO change for MLB among all the RRC connected UEs, except for a hand-in call by an operator's policy.

Thereafter, the base station may determine a service type (715). The base station may determine whether MLB is applied to each QCI=q according to an operator's policy by turning on or off qciMlb(q) (system parameter).

Therefore, when a UE of an MLB application target type has bearer for an MLB application target service type, the base station may generate a random value between 0.0 and 1.0, and when the generated random value is less than ueRatioForMlb (system parameter), the base station may select the UE as the MLB application target UE (720). Here, if the UE is not the MLB application target UE, CIO_mro(s,n) is applied to the UE, and if the UE is the MLB application target UE, when an RRC connection reconfiguration message is transmitted by an MLB operation, CIO_mro(s,n) is applied to the UE.

Here, ueRatioForMlb may be fixedly set by the operator and be automatically set by a source base station according to a base station load. When ueRatioForMlb is automatically set, ueRatioForMlb may be set by Equation 11.

$$ueRatioForMlb = min \{ ρ \times \frac{( source cell load ) - overloadThreshold}{100 - overloadThreshold} , 1.0 \} \qquad < Equation 11 >$$

where ρ is a system parameter set by an operator in a range of 0.1 to 10.0.

Hereinafter, CIO fall back according to MRO related statistics will be described. The fall back uses two methods. A first method represents a multi-step fallback mode and represents a mode that changes by CioStep dB from present CIO(s, n (i)) toward CIO_mro (s, n (i)), and a second method represents a one-step fallback mode and represents a mode that immediately changes from present CIO(s, n (i)) to CIO_mro (s, n (i)). The first method is a method of changing adjacently to CIO_mro (s, n (i)) by changing again by CioStep dB, if fall back is again necessary after changing.

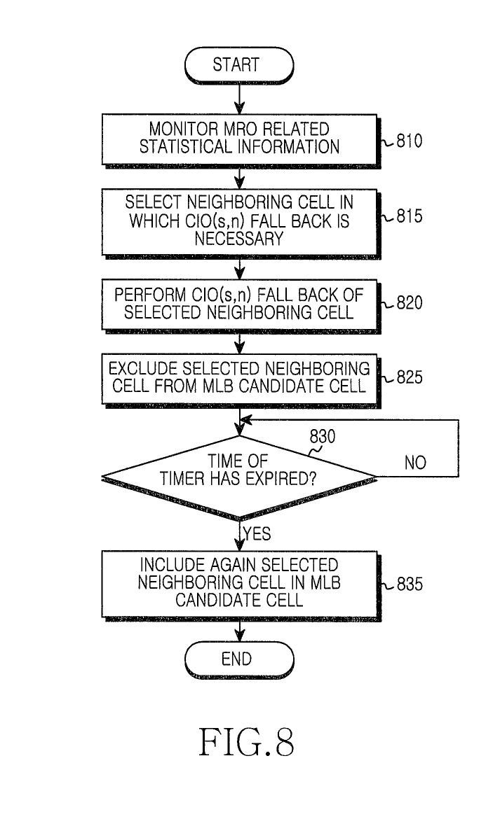

FIG. 8 is a flowchart illustrating a CIO fall back process according to MRO related statistics in a base station according to an exemplary embodiment of the present disclosure.

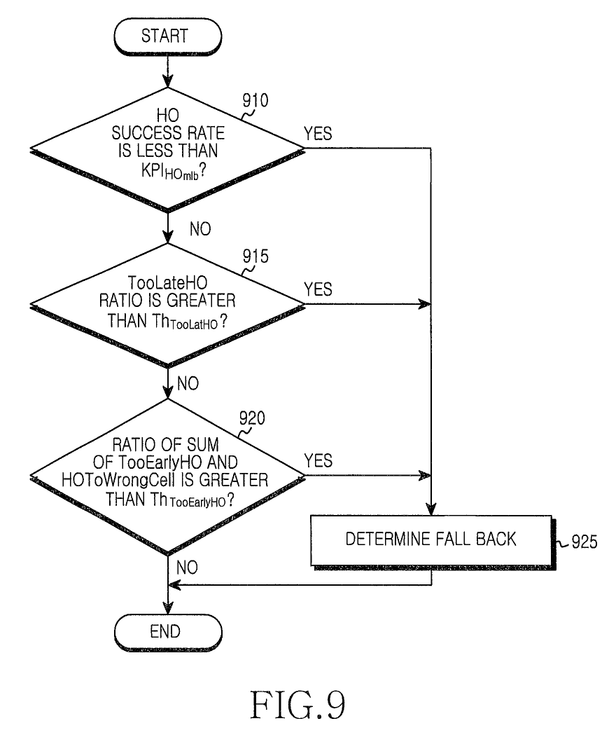

Referring to FIG. 8, the base station may monitor MRO related statistical information (810) and select a neighboring cell in which CIO(s,n) fall back is necessary (815). A process of selecting a neighboring cell in which CIO(s,n) fall back is necessary will be described with reference to FIG. 9.

Therefore, the base station may perform CIO(s,n) fall back of the selected neighboring cell (820) and exclude the selected neighboring cell from an MLB candidate cell (825). In this case, the base station may start a specific timer.

Therefore, the base station may determine whether a time of the timer has expired (830), and if a time of the timer has expired, the base station may include again the selected neighboring cell in the MLB candidate cell (835).

In a process of FIG. 8, in MRO related statistical information monitoring in which the base station performs to determine necessity of fall back, a monitoring target is as follows.

Table 2 is a table that classifies handover related problems used for an MRO function in consideration of a Radio Link Failure (RLF) generation time point and a ‘base station in which Re-establishment occurs’, and Table 3 is a table representing statistic items related to an MRO function. Statistic items of Table 3 are each collected for a (source cell and target cell) combination.

TABLE 2

| | Re-establishment Cell | | |
|---|---|---|---|
| RLF generation | Source base | Target base | Other base |
| time | station | station | station |
| Before HO | CoverageHole | N/A | TooLateHO |
| | | | (RLFBeforeTriggering) |
| HO Preparation | CoverageHole | (1)TooLateHO | HOtoWrongCell |
| | | (RLFAfterTriggering) | (RLFAfterTriggering) |
| | | (2) CoverageHole | |
| HO Execution | TooEarlyHO | CoverageHole | HOtoWrongCell |
| | (HOFailure) | | (RLFAfterTriggering) |
| After HO | TooEarlyHO | CoverageHole | HOtoWrongCell |
| | (RLFAfterHO) | | (RLFAfterHO) |

TABLE 3

| No | Statistic items | Description |
|---|---|---|
| 1 | HOAttempt | The number of HO preparation |
| | | attempt |
| 2 | HOPrepSuccess | The number of HO preparation |
| | | success |
| 3 | HOSuccess | The number of HO success |
| 4 | CoverageHoleN | The number of RLF/HO |
| | | failure by cell I direction |
| | | Coverage hole |
| 5 | TooEarlyHO.Failure | The number of Too Early |
| | | HO after transmitting |
| | | HO Command |
| 6 | TooEarlyHO.RLFAfterHO | The number of Too early |
| | | HO after completing HO |
| | | procedure |
| 7 | TooLateHO.RLFBeforeTriggering | The number of RFL before HO |
| | | triggering |
| 8 | TooLateHO.RLFAfterTriggering | The number of RFL after |
| | | transmitting HO Command |
| 9 | WrongCell.RLFAfterTriggering | The number of wrong cells |
| | | to HO before transmitting |
| | | HO Command |
| 10 | WrongCell.RLFAfterHO | The number of wrong cells |
| | | to HO after transmitting |
| | | HO Command |
| 11 | PingpongHandover | The number in which ping-pong |
| | | HO detected by ping-pong |
| | | detection algorism has occurred |
| 12 | WrongCell.RLFAfterTriggering | The number of wrong cells |
| | | to Ho before transmitting |
| | | HO Command |

FIG. 9 is a flowchart illustrating a process of selecting a neighboring cell in which CIO(s,n) fall back is necessary or to be performed in a base station according to an exemplary embodiment of the present disclosure. When CIO_mlb (s, n (i))=CIO(s, n (i)), if one of the following three conditions is satisfied, the base station may perform fall back.

Referring to FIG. 9, the base station may check a handover success rate. The base station may determine whether a HO success rate is less than KPI_{HOmlh} (system parameter and is set by an operator) (910) using Equation 12 from statistics collected from UEs to which CIO(s,n(i)) is applied, and if a HO success rate is less than KPI_{HOmlh} (system parameter and is set by an operator), the base station may determine fall back to a corresponding target base station (925).

$$\frac{HOSucess ( CIO ( s , n , ( i ) ) )}{HOPrepSucess ( CIO ( s , n ( i ) ) )} < {KPI}_{HOmlb} \qquad < Equation 12 >$$

In order to guarantee effectiveness of Equation 12, if HOAttempt(CIO(s,n(i))) is equal to or greater than the predetermined number, the base station may check an HO success rate, and if HOAttempt(CIO(s,n(i))) is less than the predetermined number, the base station may not check an HO success rate.

Alternatively, the base station may check a TooLateHO ratio. The base station may determine whether a TooLateHO ratio is greater than Th_{TooLateHO} (system parameter and is set by an operator) using Equation 13 from statistics collected from UEs to which CIO(s,n(i)) is applied (915), and if TooLateHO ratio is greater than Th_{TooLateHO} (system parameter and is set by an operator), the base station may determine fall back to a corresponding target base station (925).

$$\frac{TooLateHO}{Effective \cdot HOAttempt} > ThToolateHO \qquad < Equation 13 >$$

In Equation 13, a parameter is defined as follows.

TooLateHO=ToolateHO.RLFBeforeTriggering+TooLateHO.RLFAfterTriggeing

Effective.HOAttempt=HOSucess+TooLateHO.RLFBeforeTriggering+WrongCell.RLFAfterTriggering

where Effective.HOAttempt is different from HOAttempt represented in Table 3. Statistics are not separately collected and are obtained by Equation 13.

In order to guarantee effectiveness of Equation 13, if Effective.HOAttempt(CIO(s.n(i))) is equal to or greater than the predetermined number, the base station may check a TooLateHO ratio, and if Effective.HOAttempt(CIO(s.n(i))) is less than the predetermined number, the base station may not check a TooLateHO ratio.

Alternatively, the base station may check a ratio of TooEarlyHO+HOToWrongCell. The base station may determine whether a ratio of the sum of TooEarlyHO and HOToWrongCell is greater than TH_{TooEarlyHO} (system parameter and is set by an operator) using Equation 14 from statistics collected from UEs to which CIO(s.n(i)) is applied (920), and if a ratio of the sum of TooEarlyHO and HOToWrongCell is greater than Th_{TooEarlyHO} (system parameter and is set by an operator), the base station may determine fall back to a corresponding target base station (925). Here, a case of collecting to HOToWrongCell is expected as a result according to a kind of Too-Early-HO and thus corresponds to a case of checking a Too-Early-HO ratio.

$$\frac{TooEarlyHO + HOToWrongCell}{Effective \cdot HOAttempt} > {Th}_{TooEarlyHO} \qquad < Equation 14 >$$

In Equation 14, a parameter is defined as follows.

TooEarlyHO=TooEarlyHO.Failure+TooEarlyHO.RLFAfterHO

HOToWrongCell=WrongCell.RLFAfterTriggering+WrongCell.RLFAfterHO

However, in order to guarantee effectiveness of Equation 14, if Effective.HOAttempt(CIO(s.n(i))) is equal to or greater than the predetermined number, the base station may check a ratio of TooEarlyHO+HOToWrongCell, and if Effective.HOAttempt(CIO(s.n(i))) is less than the predetermined number, the base station may not check a ratio of TooEarlyHO+HOToWrongCell. Here, Effective.HOAttempt is different from HOAttempt represented in Table 3. Statistics are not separately collected and are obtained by Equation 14.

Hereinafter, a link operation of MLB and MRO that perform CIO adaptation will be described.

Because a CIO change period periodMlb (system parameter, e.g., eNum=(1 sec, 2 sec, 5 sec, 10 sec, . . . )) by MLB is relatively very short, compared with periodMro (system parameter and is equal to greater than a statistic collection period), which is a CIO change period by MRO and a statistic collection period (e.g., 5 minutes), when collecting MRO related statistics with an existing method, effectiveness of statistical information provided to MRO algorithm cannot be guaranteed.

Accordingly, even when MLB and MRO simultaneously operate, a method of guaranteeing effectiveness of MRO related statistical information is necessary.

For this, the base station may manage the MRO related statistics represented in Table 3, as represented in Table 4 for a source cell and a target cell n(i). That is, the base station may enable CIO(s, n(i)) to collect MRO related statistics managed based on existing CIO(s, n (i))=CIO_mro (s, n (i)) at each of CIO_min(s, n (i)) to CIO_max(s, n (i)).

TABLE 4

| CIO | | | | |
|---|---|---|---|---|
| (s, n (i)) | HOPrepAttempt | HOSuccess | . . . | PingpongHandover |
| CIO_min | — | — | | — |
| (s, n(i)) | | | | |
| CIO_min | — | — | | — |
| (s, n(i)) + 1 | | | | |
| CIO_min | — | — | | — |
| (s, n(i)) + 2 | | | | |
| . . . | | | | |
| CIO_max | — | — | | — |
| (s, n(i)) − 2 | | | | |
| CIO_max | — | — | | — |
| (s, n(i)) − 1 | | | | |
| CIO_max | — | — | | — |
| (s, n(i)) | | | | |

In Table 4, entire items represented in Table 3 are collected. A CIO change range (CIO_min, CIO_max) setting method in Table 4 is as follows.

First, a method in which an operator sets a CIO change range to a fixed value (CIO_min* to CIO_max*) may be considered. In this case, the CIO change range may be set, as represented by Equation 15.

CIO_min(s,n(i))=CIO_min*

CIO_max(s,n(i))=CIO_max* <Equation 15>

Further, a method in which the base station automatically sets a CIO change range may be considered.

That is, CIO_mro (s, n (i)) is calculated by MRO algorithm with a periodMro period, and CIO_min(s, n (i)) and CIO_max(s, n (i)) are calculated, as represented by Equation 16.

CIO_min(s,n(i))=CIO_mro(s,n(i))CIO_delta(s,n(i))

CIO_max(s,n(i))=CIO_mro(s,n(i))CIO_delta(s,n(i)) <Equation 16>

where CIO_delta (s, n (i)) may be set by an operator or may be automatically set with the following method in a range of 0 to cioDeltaMax (system parameter and is set by an operator) based on MRO related statistics.

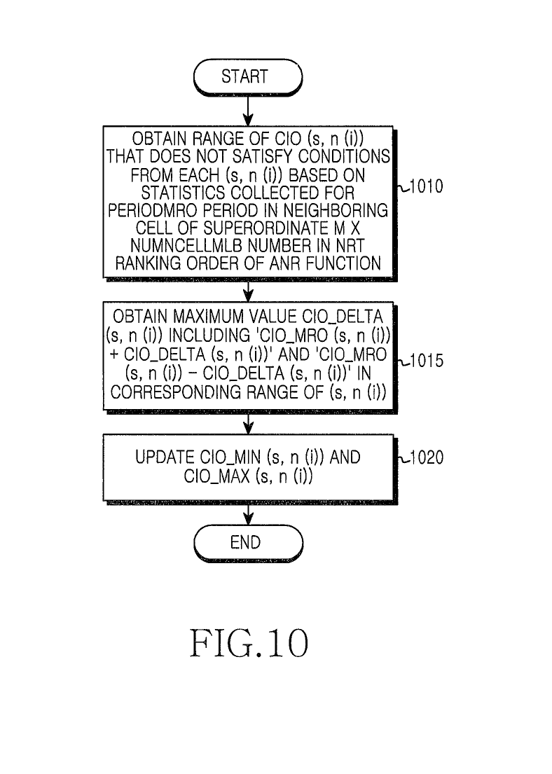

FIG. 10 is a flowchart illustrating a method of determining CIO_delta according to MRO related statistics in a base station according to an exemplary embodiment of the present disclosure.

Referring to FIG. 10, the base station may obtain a range of CIO(s, n (i)) that does not satisfy any one of three fall back conditions described with reference to FIG. 9 from each (s, n (i)) based on statistics collected for a periodMro period in neighboring base stations of the superordinate m×numNcellMlb number in NRT ranking order of an ANR function (1010). Here, m is the natural number of 1 or more and is a parameter set by an operator.

Thereafter, the base station may obtain a maximum value CIO_delta (s, n (i)) including ‘CIO_mro(s, n (i))+CIO_delta(s, n (i))’ and ‘CIO_mro(s, n (i))−CIO_delta(s, n (i))’ in the corresponding range of (s, n (i)) (1015).

Thereafter, the base station may update CIO_min(s, n (i)) and CIO_max(s, n (i)) using the maximum value CIO_delta(s, n (i)) and Equation 16 (1020).

According to various exemplary embodiments, in a method for a load balancing using statistical information in a base station of a wireless communication system, the method includes a process of measuring a load of at least one cell managed by the base station; a process of exchanging load information of the measured cell with at least one neighboring base station; a process of determining at least one MLB application candidate cell in which a CIO change is necessary using the load information; a process of determining at least one MLB application target cell in the at least one MLB application candidate cell; a process of performing a CIO change procedure with the at least one MLB application target cell; a process of selecting at least one UE to notify a CIO change; and a process of notifying the selected at least one UE of the CIO change.

The method may further include a process of monitoring MRO related statistical information; a process of selecting at least one neighboring cell in which CIO fall back is necessary using the MRO related statistical information; a process of performing CIO fall back of the selected at least one neighboring cell; and a process of excluding at least one neighboring cell, having performed CIO fall back from an MLB candidate cell for a predetermined time.

The process of selecting at least one neighboring cell in which CIO fall back is necessary using the MRO related statistical information may include a process of selecting a neighboring cell satisfying at least one of when an HO success rate is less than a first critical value, when a TooLateHO ratio exceeds a second critical value, or when a ratio of the sum of TooEarlyHO and HOToWrongCell exceeds a third critical value.

The process of monitoring MRO related statistical information may include a process of monitoring MRO related statistical information according to a CIO change period within a CIO change range of the source cell of the base station and the at least one neighboring cell.

The method may further include a process of including at least one neighboring cell, having performed the CIO fall back in an MLB candidate cell after the predetermined time.

The process of determining at least one MLB application candidate cell in which a CIO change is necessary using the load information may include a process of determining whether a source cell load of the base station is greater than a fourth critical value and whether a ratio of a source cell load of the base station and a load of a corresponding neighboring cell is greater than a fifth critical value, or a process of determining whether a source cell load of the base station is greater than a fourth critical value and whether a difference between a source cell load of the base station and a load of the corresponding neighboring cell is greater than a sixth critical value.

The process of determining at least one MLB application target cell in the at least one MLB application candidate cell may include a process of selecting the predetermined number of MLB application candidate cells in the at least one MLB application candidate cell in NRT ranking order of an ANR function.

The process of performing a CIO change procedure with the at least one MLB application target cell may include a process of notifying, by a source cell of the base station, a CIO change by transmitting a first message to a corresponding target MLB cell and receiving a response message to the first message from the corresponding MLB target cell.

The method may further include a process of changing CIO of the corresponding MLB target cell, when the response message is a success response message.

The method may further include a process of determining whether change CIO satisfies a ping pong prevention condition, when the response message is a failure response message and a process of changing CIO of the corresponding MLB target cell, if change CIO satisfies a ping pong prevention condition.

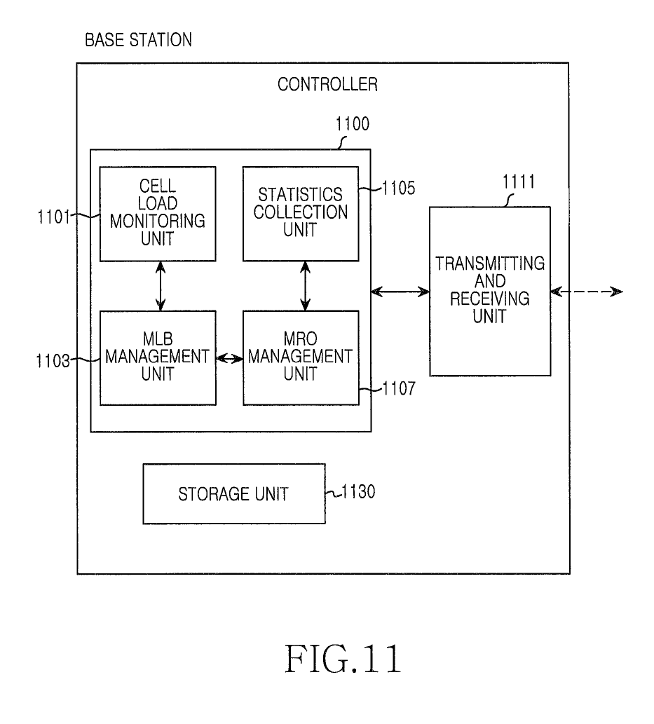

FIG. 11 is a block diagram illustrating a configuration of a base station in a wireless communication system according to an exemplary embodiment of the present disclosure.

Referring to FIG. 11, the base station may include a controller 1100, a transmitting and receiving unit 1111, and a storage unit 1130, and particularly, the controller 1100 may include a cell load monitoring unit 1101, an MLB management unit 1103, a statistics collection unit 1105, and an MRO management unit 1107.

The transmitting and receiving unit 1111 may perform a function of transmitting and receiving a signal to and from a neighboring cell and a user UE according to the control of the controller 1100. Particularly, the transmitting and receiving unit 1111 may control and process a function of exchanging load information and a message for CIO change notification with a neighboring cell.

The controller 1100 may control general operations of the cell. Particularly, according to the exemplary embodiment of the present disclosure, the controller 1100 may control a link operation function of an MLB function of the MLB management unit 1103 and a CIO fall back function using statistical information of the MRO management unit 1107.

For example, the controller 1100 may control the MLB management unit 1103 and the MRO management unit 1107 to enable CIO(s, n (i)) to collect MRO related statistics managed based on existing CIO(s, n (i))=CIO_mro(s, n (i)) from each of CIO_min(s, n (i)) to CIO_max(s, n (i)), as represented in Table 4.

The storage unit 1130 may store a basic program and setting information necessary for operation of the cell. Particularly, the storage unit 1130 may store Tables 1 to 4. The storage unit 1130 may update data and provide stored data according to the control of the controller 1100.

The cell load monitoring unit 1101 may periodically calculate a source cell load (its own load) and monitor loads of a source cell and a neighboring cell. Particularly, the cell load monitoring unit 1101 may measure a load of a source cell using Equation 1 and provide exchanged loads of the neighboring cell and the source cell to the MLB management unit 1103.

The MLB management unit 1103 may select an MLB candidate cell in which CIO(s,n) adaptation is necessary based on a cell load in which the cell load monitoring unit 1101 outputs. The MLB management unit 1103 may select a CIO change target cell among the selected MLB candidate cells, perform a mobility change request process with the selected target cell, select a target UE, and perform an RRC reconfiguration process with the selected UE, thereby performing an MLB process of the present exemplary embodiment.

The statistics collection unit 1105 may collect statistic information of items represented in Table 3 and provide the statistic information to the MRO management unit 1107.

The MRO management unit 1107 may select a neighboring cell in which CIO(s,n) fall back is necessary based on statistical information in which the statistic collection unit 1105 provides, perform CIO(s,n) fall back of the selected neighboring cell, and exclude the selected neighboring cell from an MLB candidate cell. In this case, the MRO management unit 1107 may start a specific timer. When a time of the timer has expired, the MRO management unit 1107 may include again the selected neighboring cell in an MLB candidate cell.

A device of a base station that performs load balancing using statistical information in a wireless communication system includes: a base station load monitoring unit that measures a load of at least one cell managed by the base station and that exchanges load information of the measured cell with at least one neighboring base station; an MLB management unit that determines at least one MLB application candidate cell in which a CIO change is necessary using the measured load information and that determines at least one MLB application target cell in the at least one MLB application candidate cell and that performs a CIO change procedure with the at least one MLB application target cell and that selects at least one UE to notify a CIO change; and a transmitting and receiving unit that notifies the selected at least one UE of the CIO change.

The transmitting and receiving unit may further include an MRO management unit that monitors MRO related statistical information and that selects at least one neighboring cell in which CIO fall back is necessary using the MRO related statistical information and that performs CIO fall back of the selected at least one neighboring cell and that excludes at least one neighboring cell, having performed CIO fall back from an MLB candidate cell for a predetermined time.

When the MRO management unit selects at least one neighboring cell in which CIO fall back is necessary using the MRO related statistical information, the MRO management unit may select a neighboring cell that satisfies at least one of when an HO success rate is less than a first critical value, when a TooLateHO ratio exceeds a second critical value, or when a ratio of the sum of TooEarlyHO and HOToWrongCell exceeds a third critical value.

When monitoring MRO related statistical information, the statistic collection unit may monitor MRO related statistical information according to a CIO change period within a CIO change range of at least one neighboring cell and a source cell of the base station.

After the predetermined time, the MRO management unit may include at least one neighboring cell, having performed the CIO fall back in an MLB candidate target cell.

When the MLB management unit determines at least one MLB candidate cell in which a CIO change is necessary using the load information, the MLB management unit may determine whether a source cell load of the base station is greater than a fourth critical value and whether a ratio of a load of a source cell of the base station and a load of a corresponding neighboring cell is greater than a fifth critical value or may determine whether a load of a source cell of the base station is greater than a fourth critical value and whether a difference between a load of a source cell of the base station and a load of a corresponding neighboring cell is greater than a sixth critical value.

When the MLB management unit determines at least one MLB application target cell in the at least one MLB application candidate cell, the MLB management unit may select the predetermined number of MLB application candidate cells in NRT ranking order of an ANR function in the at least one MLB application candidate cell.

When the MLB management unit performs a CIO change procedure with the at least one MLB application target cell, the base station may notify a CIO change by transmitting a first message to a corresponding MLB target cell using the transmitting and receiving unit and receive a response message to the first message from the corresponding target MLB cell through the transmitting and receiving unit.

When the response message is a success response message, the MLB management unit may change CIO of the corresponding MLB target cell.

When the response message is a failure response message, the MLB management unit may determine whether change CIO satisfies a ping pong prevention condition, and if change CIO satisfies a ping pong prevention condition, the MLB management unit may change CIO of the corresponding MLB target cell.

The present disclosure has an advantage that can perform an MLB and that can coexist with an MRO function without lowering a handover success rate in a wireless communication system.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. A method for a load balancing in a wireless communication system, the method comprising:
monitoring loads of a source cell and at least one neighboring cell;
determining at least one candidate neighboring cell to perform handover related parameter adaptation for load balancing in consideration of at least one of an overload condition of the source cell, a load ratio condition of the source cell and the neighboring cell, or a load difference condition between the source cell and the neighboring cell;
determining at least one target neighboring cell from the at least one candidate neighboring cell using a function for determining a priority of neighboring cells based on handover related statistics; and
adapting a handover related parameter value for the load balancing for the at least one target neighboring cell.

2. The method of claim 1, wherein adapting the handover related parameter value comprises:
sending a request for a handover related parameter change to the at least one target neighboring cell;
determining, when a change failure response corresponding to the change request is received from the at least one target neighboring cell, whether the at least one target neighboring cell satisfies a ping pong prevention condition; and
increasing, if the cell satisfies the ping pong prevention condition, a value of the handover related parameter of the at least one target neighboring cell by a predetermined step.

3. The method of claim 2, further comprising not including the at least one target neighboring cell in the at least one candidate neighboring cell to perform handover related parameter adaptation for the load balancing for a previously defined time without changing a value of the handover related parameter of the at least one target neighboring cell, if the cell does not satisfy the ping pong prevention condition.

4. The method of claim 3, further comprising including the at least one target neighboring cell in the at least one candidate neighboring cell to perform handover related parameter adaptation for the load balancing after a previously defined time.

5. The method of claim 2, further comprising increasing a value of the handover related parameter of the at least one target neighboring cell by a predetermined step, when a change success response corresponding to the change request is received.

6. The method of claim 1, further comprising:
monitoring Mobility Robustness Optimization (MRO) related statistical information;
selecting at least one neighboring cell to perform Cell Individual Offset (CIO) fall back using the MRO related statistical information;
performing CIO fall back of the selected at least one neighboring cell; and
not including the at least one neighboring cell, having performed the CIO fall back and the at least one target neighboring cell in at least one candidate neighboring cell to perform handover related parameter adaptation for the load balancing for a previously defined time.

7. The method of claim 6, wherein selecting the at least one neighboring cell comprises selecting a neighboring cell satisfying at least one of when an HO success rate is less than a first value, when a TooLateHO ratio exceeds a second value, or when a ratio of the sum of TooEarlyHO and HOToWrongCell exceeds a third value.

8. The method of claim 6, further comprising: including the at least one neighboring cell, having performed the CIO fall back and the at least one target neighboring cell in the at least one candidate neighboring cell to perform handover related parameter adaptation for the load balancing after a previously defined time.

9. The method of claim 6, wherein monitoring the MRO related statistical information comprises monitoring the MRO related statistical information according to a CIO change period within a CIO change range of the source cell and the at least one neighboring cell.

10. The method of claim 1, further comprising:
selecting at least one target User Equipment (UE) based on one of a UE type and a service type; and
notifying the at least one target UE of the adapted handover related parameter value.

11. A load balancing device in a wireless communication system, the load balancing device comprising:
a transmitter and receiver; and
a controller configured to monitor, via the transmitter and receiver, a load of a source cell and at least one neighboring cell; determine at least one candidate neighboring cell to perform handover related parameter adaptation for load balancing in consideration of at least one of an overload condition of the source cell, a load ratio condition of the source cell and the neighboring cell, or a load difference condition between the source cell and the neighboring cell; determine at least one target neighboring cell from the at least one candidate neighboring cell using a function for determining a priority of neighboring cells based on handover related statistics; and adapt a handover related parameter value for the load balancing for the at least one target neighboring cell.

12. The load balancing device of claim 11, wherein the controller is configured to send, via the transmitter, a request for a handover related parameter change to the at least one target neighboring cell; determine whether the at least one target neighboring cell satisfies a ping pong prevention condition, when a change failure response corresponding to the change request is received from the at least one target neighboring cell; and increase a value of the handover related parameter of the at least one target neighboring cell by a predetermined step, if the cell satisfies the ping pong prevention condition.

13. The load balancing device of claim 12, wherein the controller is configured to not change a value of the handover related parameter of at least one target neighboring cell, if the cell does not satisfy the ping pong prevention condition and does not comprise the at least one target neighboring cell in the at least one candidate neighboring cell to perform handover related parameter adaptation for the load balancing for a previously defined time.

14. The load balancing device of claim 13, wherein the controller is configured to include the at least one target neighboring cell in the at least one candidate neighboring cell to perform handover related parameter adaptation for the load balancing after the previously defined time.

15. The load balancing device of claim 12, wherein the controller is configured to increase a value of the handover related parameter of the at least one target neighboring cell by a predetermined step, when the receiver receive a change success response corresponding to the change request.

16. The load balancing device of claim 11, wherein the controller is configured to select at least one neighboring cell to perform Cell Individual Offset (CIO) fall back using Mobility Robustness Optimization (MRO) related statistical information, performs CIO fall back of the selected at least one neighboring cell, and does not include the at least one neighboring cell, having performed the CIO fall back and the at least one target neighboring cell in at least one candidate neighboring cell to perform handover related parameter adaptation for the load balancing for a previously defined time.

17. The load balancing device of claim 16, wherein the MLB controller is configured to select a neighboring cell that satisfies at least one of when a HO success rate is less than a first value, when a TooLateHO ratio exceeds a second value, or when a ratio of the sum of TooEarlyHO and HOToWrongCell exceeds a third value.

18. The load balancing device of claim 16, wherein the at least one neighboring cell, having performed CIO fall back and the at least one target neighboring cell are included in the at least one candidate neighboring cell to perform handover related parameter adaptation for the load balancing after a previously defined time.

19. The load balancing device of claim 16, wherein the MRO related statistical information is monitored according to a CIO change period within a CIO change range of the source cell and the at least one neighboring cell.

20. The load balancing device of claim 11, wherein controller is configured to select at least one target User Equipment (UE) based on one of a UE type and a service type and notify, via the transmitter, the at least one target UE of the adapted handover related parameter value.
